(19) United States
(12) Patent Application Publication
(10) Pub. No.: US 2024/0371408 A1
(43) Pub. Date: Nov. 7, 2024

(54) METHOD OF EDITING A VIDEO FILE

(71) Applicant: BLACKBIRD PLC, London (GB)

(72) Inventor: Stephen STREATER, London (GB)

(21) Appl. No.: 18/687,028

(22) PCT Filed: Aug. 30, 2022
(86) PCT No.: PCT/GB2022/052215

§ 371 Date: Feb. 27, 2024

(30) Foreign Application Priority Data
Aug. 27, 2021 (GB) 2112276.7

(51) Int. Cl. G11B 27/031; G06F 3/0354; G06F 3/04842; G06F 3/04847; G06F 3/04886

(52) U.S. Cl. CPC G11B 27/031; G06F 3/03543; G06F 3/04842; G06F 3/04847; G06F 3/04886; G06F 2203/04803

(57) ABSTRACT

A computer-implemented method of editing a video file, including the steps of: (i) receiving a selection of a video file to edit; (ii) presenting a frame of the video file on a screen of a computing device; (iii) receiving an input corresponding to a position on the presented frame of the video file on the screen, the input comprising a width coordinate and a height coordinate; (iv) presenting a frame of the video file on the screen of the computing device; (v) repeating steps (iii) and (iv) until an input is received by the computing device identifying the presented frame as a start frame of a portion of the video file; (vi) repeating steps (iii) and (iv) until an input is received identifying the presented frame as an end frame of the portion of the video file; (vii) saving the start frame portion and end frame portion.

### BACKGROUND OF THE INVENTION

### 1. Field of the Invention

The field of the invention relates to computer-implemented methods of editing a video file, and to related computer systems and computer program products.

### 2. Technical Background

The internet has created a rapacious demand for content, and increasingly, video content.

Making high quality video content has traditionally been a skilled professional job, where making good quality video content has required considerable technique-and experience. As a result, much of the professional video content viewed-from films and television to sports highlights and clipping-on social media has been edited by dedicated professionals using sophisticated workflows, often with significant finance behind them.

There is a burgeoning alternative to producing video content-dubbed the Creator Economy. This includes creative people who would like to express themselves-and monetise their content-in video. The estimated greater than 50 million creators cover a vast range of skills, such as: Yoga teachers, tennis coaches, historians, teachers, knitters, cooks, chess players and stand-up comics, for example.

What all these creative people have in common is that, for them, making video content is not their main skill-or even something they want to spend much time on. The key for them is that they need video content to promote and to monetize their skill.

And without the budgets to finance someone else to make their video content, these creative people find that they either produce poor, unprofessional content, or spend a disproportionate time and expense creating their video content themselves.

There is a need to simplify and speed up the process of video content creation-in particular video editing.

### 3. Discussion of Related Art

JP2010081147 (A), published 8 Apr. 2010, and JP5003641 (B2) state that a problem is to confirm an editing position by transmitting images of a predetermined time before and after an editing position to a user terminal connected via a communication network, and arbitrarily shift the confirmed editing position by the user terminal as necessary, to easily redo edits. The stated solution is that a video recorder is connected to a relay server on the Internet, and editing work is performed from a user terminal (particularly a mobile phone). Upon receiving a request from the user terminal, the network transmitting/receiving unit creates editing data for network transmission, which is a still image limited to a predetermined time before and after the editing position according to the dubbing candidate information, and transmits the created data to the user terminal through the relay server. This network transmission edit data is displayed on the screen of the user terminal as an edited screen image of the program recorded by the video recorder. The user can scroll the screen and slide the editing position to redo the editing.

JP2006269068 (A), published 5 Oct. 2006, and JP4161279 (B2) state that a problem is to enable quick real-time editing to be performed, which relates to a display management device, a data display method, and a clipping image data display method. The stated solution is utilizing a user interface displayed by graphical images allows clipping image data to be displayed on an in clipping display area and an out clipping display area, while viewing source video data displayed on a video display area, and displaying clipping images on the clipping display area and an event display area in the order of marking and event registration allows the quick real-time editing to be performed. FIG. 7 is a prior art Figure from JP2006269068 (A), showing a diagram of a graphical display for a graphical user interface displayed on a monitor of a computer.

### SUMMARY OF THE INVENTION

According to a first aspect of the invention, there is provided a computer-implemented method of editing a video file, the method including the steps of:
(i) receiving a selection of a video file to edit, the video file including a duration;
(ii) presenting a frame of the video file (e.g. a first frame of the video file) on a screen of a computing device, the computing device including the screen;
(iii) the computing device receiving an input corresponding to a position on the presented frame of the video file on the screen of the device, the input comprising a width coordinate and a height coordinate;
(iv) presenting a frame of the video file on the screen of the computing device, the presented frame being a frame at a time in the video file that corresponds to the width coordinate as a proportion of the width of the presented frame on the screen, or to the height coordinate as a proportion of the height of the presented frame on the screen, of the duration of the video file, from the start of the video file;
(v) repeating steps (iii) and (iv) until an input is received by the computing device identifying the presented frame as a start frame of a portion of the video file;
(vi) repeating steps (iii) and (iv) until an input is received by the computing device identifying the presented frame as an end frame of the portion of the video file;
(vii) saving the portion of the video file that is defined by the start frame of the portion of the video file received in step (v) and the end frame of the portion of the video file received in step (vi).

An advantage is that a portion of a video file may be identified and saved very quickly. An advantage is that a portion of a video file may be identified and saved without requiring substantial skill in operating video editing software. An advantage is that a portion of a video file may be identified and saved without requiring substantial investment in video editing software. An advantage is rapid navigation between frames.

The method may be one wherein the computing device is a PC, laptop, desktop computer, tablet computer, smartphone, mobile phone, or a smart TV.

The method may be one wherein the screen area includes four edges, wherein the frame of the video file presented on the screen of the computing device includes edges which coincide with the four edges of the screen area. An advantage is that the full screen extent is used to show the frame, which allows a portion of a video file to be identified and saved very quickly.

The method may be one wherein the frame of the video file presented on the screen of the computing device is presented over the whole of the screen area. An advantage is that the full screen area is used to show the frame, which allows a portion of a video file to be identified and saved very quickly.

The method may be one wherein the frame of the video file presented on the screen of the computing device is presented in a window within the screen area. An advantage is that other content, such as other windows, may be presented on the screen.

The method may be one wherein the computing device is arranged to receive user input via a pointing device (e.g. a mouse, or a stylus). An advantage is that a portion of a video file may be identified and saved very quickly.

The method may be one wherein the input received by the computing device corresponding to the position on the presented frame of the video file on the screen of the device is the position of a pointer (e.g. a cursor) displayed on the screen, the input comprising a width coordinate and a height coordinate. An advantage is that a portion of a video file may be identified and saved very quickly.

The method may be one wherein the position of the pointer (e.g. a cursor) displayed on the screen is movable using a user input device, such as a mouse, (e.g. without pressing any mouse buttons), or such as a keyboard (e.g. using arrow keys) or a trackpad (e.g. on a laptop). An advantage is that a portion of a video file may be identified and saved very quickly.

The method may be one wherein when the pointer is further left than the far left of the window, it is the first frame of the video that is displayed.

The method may be one wherein when the pointer is further right than the far right of the window, it is the last frame of the video that is displayed.

The method may be one wherein when the pointer is further up than the top of the window, it is the first frame of the video that is displayed.

The method may be one wherein when the pointer is further down than the bottom of the window, it is the last frame of the video that is displayed.

The method may be one the input received by the computing device identifying the presented frame as the start frame of the portion of the video file includes a pressing down of a mouse button. An advantage is that a portion of a video file may be identified very quickly.

The method may be one wherein the input received by the computing device identifying the presented frame as the end frame of the portion of the video file includes a release of the previously pressed down mouse button. An advantage is that a portion of a video file may be identified very quickly.

The method may be one where the input received by the computing device identifying the presented frame as the end frame of the portion of the video file includes a press of a different button of the mouse. An advantage is that a portion of a video file may be identified very quickly.

The method may be one wherein the input received by the computing device identifying the presented frame as the start frame of the portion of the video file includes a mouse click, and the input received by the computing device identifying the presented frame as the end frame of the portion of the video file includes a further mouse click. An advantage is that a portion of a video file may be identified very quickly.

The method may be one wherein the computing device is arranged to receive user input via a touch screen interface. An advantage is that a portion of a video file may be identified and saved very quickly.

The method may be one wherein the input received by the computing device corresponding to the position on the presented frame of the video file on the screen of the device, the input comprising a width coordinate and a height coordinate, is the position of a touch on the screen. An advantage is that a portion of a video file may be identified and saved very quickly.

The method may be one wherein when the position of the touch on the screen is further left than the far left of the window, it is the first frame of the video that is displayed.

The method may be one wherein when the position of the touch on the screen is further right than the far right of the window, it is the last frame of the video that is displayed.

The method may be one wherein when the position of the touch on the screen is further up than the top of the window, it is the first frame of the video that is displayed.

The method may be one wherein when the position of the touch on the screen is further down than the bottom of the window, it is the last frame of the video that is displayed.

The method may be one wherein a long duration press (e.g. at least two seconds) is used to confirm the initiation of a selection of the start frame of the video, and the selection of a portion of the video, and the two ends of the clip may be marked by detecting a sliding a finger across the screen, and the detecting a finger release from the screen to define the end frame of the portion of the video. An advantage is that a portion of a video file may be identified and saved very quickly.

The method may be one wherein a long duration press (e.g. at least two seconds) is used to confirm the initiation of a selection of the start frame of the video, and a further long press (e.g. at least two seconds) indicates the end of the selection, to define the end frame of the portion of the video. An advantage is that a portion of a video file may be identified and saved very quickly.

The method may be one wherein the selection of the portion of the video is completed by relinquishing the connection to the screen (for example as inferred by the device by no touch having been received by the device in a predefined time interval such as four seconds), and the final selected frame marks the end of the selected portion of the video.

The method may be one in which the selected start and end points of the selected portion of the video are shown on the screen, and optionally the length of selected clips. An advantage is that a portion of a video file may be identified and saved very quickly.

The method may be one in which a selectable icon is provided in the user interface, which is selectable to clear the selected start frame and the selected end frame of a video portion. An advantage is that a portion of a video file may be identified and saved very quickly.

The method may be one wherein the video file is stored in a compressed format structure on a server. An advantage is that a portion of a video file may be identified and saved very quickly.

The method may be one wherein the video file is stored in the compressed format structure on the server, the compressed format structure including a hierarchy of levels of temporal resolution of frames, each respective level of the hierarchy including frames corresponding to a respective temporal resolution of the respective level of the hierarchy, but not including frames which are included in one or more lower levels of lower temporal resolution of frames of the hierarchy. An advantage is that a portion of a video file may be identified and saved very quickly.

The method may be one wherein the minimum number of frames to download to the computing device and decompress is calculated from the number of pixels horizontally or vertically across the video image. An advantage is that a portion of a video file may be identified and saved very quickly.

The method may be one wherein only enough frames are downloaded to allow every pixel across the image, which is a possible position of the pointer or touch, to correspond to a different frame. An advantage is that a portion of a video file may be identified and saved very quickly.

The method may be one wherein previously displayed frames are cached, e.g. at the computing device, or e.g. at a server. An advantage is that a portion of a video file may be identified and saved very quickly.

The method may be one wherein the screen output is arranged for landscape mode, as would typically be the case for a desktop computer, a laptop computer, a smart TV or a tablet computer.

The method may be one wherein the screen output is arranged for portrait mode, as would typically be the case for a smartphone.

The method may be one wherein saving the portion of the video file is performed automatically. An advantage is that a portion of a video file may be identified and saved very quickly.

The method may be one wherein saving the portion of the video file is performed automatically, using an automatically generated filename. An advantage is that a portion of a video file may be identified and saved very quickly.

The method may be one wherein saving the portion of the video file is performed after offering on the screen of the computing device the portion of the video for saving, receiving a filename, and saving the portion of the video file, using the received filename.

The method may be one wherein the saved portion of the video file is sendable to social media such as Instagram or TikTok, possibly via a pop up window which may be used to fill in any text description or hashtags, or the like.

The method may be one wherein the method includes highlighting a portion of the width of the presented frame corresponding to the portion of video between the start frame identified in step (v) and the width coordinate of the input in step (iii) corresponding to the position on the presented frame of the video file on the screen of the device. An advantage is tracking the selectable content, without reducing the size of the presented frame.

The method may be one wherein the method includes highlighting a portion of the height of the presented frame corresponding to the portion of video between the start frame identified in step (v) and the height coordinate of the input in step (iii) corresponding to the position on the presented frame of the video file on the screen of the device. An advantage is tracking the selectable content, without reducing the size of the presented frame.

The method may be one wherein the highlighted portion is highlighted by dimming the non-highlighted portion. An advantage is tracking the selectable content, without reducing the size of the presented frame.

The method may be one wherein differently shaded parts of the image correspond to different selected time intervals of the video, represented in the horizontal dimension of the image, or represented in the vertical dimension of the image. An advantage is tracking the selected content, without reducing the size of the presented frame.

The method may be one wherein the start and end points of the portion of the video are selectable in either order. An advantage is that a portion of a video file may be identified and saved very quickly.

The method may be one wherein the start point is determined as the earlier of the two selected points in steps (v) and (vi), and the end point is determined as the later of the two selected points in steps (v) and (vi).

The method may be one wherein a selected portion of the video content is appended into a video window, where one or more clips are collectable in the video window to form a video that is a composite of selected portions of the video content. An advantage is that portions of a video file may be identified and saved very quickly.

The method may be one wherein the video that is a composite of the selected portions of the video content is stored in response to receiving a user command. An advantage is that portions of a video file may be identified and saved very quickly.

The method may be one wherein the stored video that is a composite of the selected portions of the video content is sent to social media.

The method may be one wherein the method of editing a video to create a clip video which includes one or more portions of an original video, is provided in a web browser interface, the web browser running on a computing device such as a smartphone, a desktop computer, a tablet computer, a laptop computer, or a smart TV.

The method may be one wherein the method of editing a video to create a clip video which includes one or more portions of an original video, is provided in an app downloadable to the computing device, wherein the computing device is a smartphone, a desktop computer, a tablet computer, a laptop computer, or a smart TV.

The method may be one wherein the video file that is being edited is locally stored on the computing device.

The method may be one wherein the video file that is being edited is stored on a server in communication with the computing device.

The method may be one wherein the edited video file is locally stored on the computing device.

The method may be one wherein the edited video file is stored on a server in communication with the computing device.

The method may be one wherein a video navigation tool is displayed on the screen of the computing device, the navigation tool arranged to receive user input. An advantage is that portions of a video file may be identified and saved very quickly.

The method may be one wherein the video navigation tool includes trim buttons for the start frame of the portion and for the end frame of the portion, to make them frame accurate. An advantage is that portions of a video file may be identified and saved very quickly.

The method may be one wherein the pointer (e.g. a cursor) is movable on the screen, orthogonally to the length of the video navigation tool, and in response in the video navigation tool the number of frames represented locally in the navigation tool is decreased locally, i.e. the number of frames represented in the navigation tool per unit distance along the navigation tool is decreased locally. An advantage is that portions of a video file may be identified and saved very quickly. An advantage is rapid navigation between frames.

The method may be one wherein audio scrubbing is available during video navigation. An advantage is that portions of a video file may be identified and saved very quickly.

The method may be one including facilitating navigation of a sequence of source images, the method using tokens representing each source image which are scaled versions of each source image and which are arranged adjacently on a display device in a continuous band of token images so that a pointer device (or a touch on a touch screen) can point to a token and the identity of the corresponding image is available for further processing. An advantage is that portions of a video file may be identified and saved very quickly. An advantage is rapid navigation between frames.

The method may be one in which the tokens are one pixel in width, or one pixel in height. An advantage is that portions of a video file may be identified and saved very quickly. An advantage is rapid navigation between frames.

The method may be one in which the method includes receiving video data comprising the steps of: receiving at least one chunk of video data comprising a number of sequential key video frames where the number is at least two and, constructing at least one delta frame between a nearest preceding key frame and a nearest subsequent key frame from data contained in the either or each of the nearest preceding and subsequent frames. An advantage is rapid navigation between frames.

The method may be one wherein the delta frame is composed of a plurality of component blocks or pixels and each component of the delta frame is constructed according to data indicating it is one of: the same as the corresponding component in the nearest preceding key frame, or the same as the corresponding component in the nearest subsequent key frame, or a new value compressed using some or all of the spatial compression of the delta frame and information from the nearest preceding and subsequent frames. An advantage is rapid navigation between frames.

The method may be one wherein after the step of construction, the delta frame is treated as a key frame for the construction of one or more further delta frames. An advantage is rapid navigation between frames.

The method may be one wherein delta frames are continued to be constructed in a chunk until either: a sufficiently good predetermined image playback quality criterion is met or the time constraints of playing the video in real time require the frames to be displayed.

The method may be one including providing one or more of responsive jog/shuttle, video scrubbing and fast subclip selection.

According to a second aspect of the invention, there is provided a computer system configured to edit a video file, the computer system including a computer device including a screen, the computer system configured to:
(i) receive a selection of a video file to edit, the video file including a duration;
(ii) present a frame of the video file (e.g. a first frame of the video file) on the screen of the computing device;
(iii) receive on the computing device an input corresponding to a position on the presented frame of the video file on the screen of the device, the input comprising a width coordinate and a height coordinate;
(iv) present on the screen of the computing device a frame of the video file, the presented frame being a frame at a time in the video file that corresponds to the width coordinate as a proportion of the width of the presented frame on the screen, or to the height coordinate as a proportion of the height of the presented frame on the screen, of the duration of the video file, from the start of the video file;
(v) repeat (iii) and (iv) until an input is received by the computing device identifying the presented frame as a start frame of a portion of the video file;
(vi) repeat (iii) and (iv) until an input is received by the computing device identifying the presented frame as an end frame of the portion of the video file;
(vii) save the portion of the video file that is defined by the start frame of the portion of the video file received in (v) and the end frame of the portion of the video file received in (vi).

An advantage is that a portion of a video file may be identified and saved very quickly. An advantage is that a portion of a video file may be identified and saved without requiring substantial skill in operating video editing software. An advantage is that a portion of a video file may be identified and saved without requiring substantial investment in video editing software. An advantage is rapid navigation between frames.

The computer system may be one configured to perform a method of any aspect of the first aspect of the invention.

According to a third aspect of the invention, there is provided a computer program product executable on a computing device including a screen, the computer program product executable on the computing device to:
(i) receive a selection of a video file to edit, the video file including a duration;
(ii) present a frame of the video file (e.g. a first frame of the video file) on the screen of the computing device;
(iii) receive an input corresponding to a position on the presented frame of the video file on the screen of the device, the input comprising a width coordinate and a height coordinate;
(iv) present on the screen of the computing device a frame of the video file, the presented frame being a frame at a time in the video file that corresponds to the width coordinate as a proportion of the width of the presented frame on the screen, or to the height coordinate as a proportion of the height of the presented frame on the screen, of the duration of the video file, from the start of the video file;
(v) repeat (iii) and (iv) until an input is received identifying the presented frame as a start frame of a portion of the video file;
(vi) repeat (iii) and (iv) until an input is received identifying the presented frame as an end frame of the portion of the video file;
(vii) save the portion of the video file that is defined by the start frame of the portion of the video file received in (v) and the end frame of the portion of the video file received in (vi).

An advantage is that a portion of a video file may be identified and saved very quickly. An advantage is that a portion of a video file may be identified and saved without requiring substantial skill in operating video editing software. An advantage is that a portion of a video file may be identified and saved without requiring substantial investment in video editing software. An advantage is rapid navigation between frames.

The computer program product may be executable on the computing device to perform a method of any aspect of the first aspect of the invention.

Aspects of the invention may be combined.

### BRIEF DESCRIPTION OF THE FIGURES

Aspects of the invention will now be described, by way of example(s), with reference to the following Figures, in which:

FIG. 1 shows an example user interface for selecting a portion of a video, in which the non-shaded part of the image on the screen corresponds to the selected time interval of the video, represented in the horizontal dimension of the image on the screen.

FIG. 2 shows an example of a user interface for selecting a portion of a video, in which a first frame in a video is shown on a screen.

FIG. 3 shows an example of a user interface for selecting a portion of a video, in which a final frame in a video is shown on a screen.

FIG. 4 shows an example of a user interface for selecting a portion of a video, in which a first frame in a video is shown in a window on a screen.

FIG. 5 shows an example of a user interface for selecting a portion of a video, in which a final frame in a video is shown in a window on a screen.

FIG. 6 shows an example user interface for selecting a portion of a video, in which the non-shaded part of the image in the window on the screen corresponds to the selected time interval of the video, represented in the horizontal dimension of the image in the window on the screen.

FIG. 7 shows a diagram of a graphical display for a graphical user interface displayed on a monitor of a computer, of the prior art.

FIG. 8 is an example of a computer display providing a method of enabling efficient navigation of video.

FIG. 9A is an example of a sequence of source image frames processed to provide a method of enabling efficient navigation of video.

FIG. 9B is an example of additional horizontal reductions, in a method of enabling efficient navigation of video.

FIG. 10 is a schematic diagram of a sequence of video frames.

FIG. 11 is a schematic diagram illustrating an example of a construction of a delta frame.

FIG. 12 is a schematic diagram of an example of a media player.

### DETAILED DESCRIPTION

In an example, there is provided a method for rapidly identifying relevant sections of video clips for use in an edited video, and a system for carrying out this method, including providing, for example, responsive jog/shuttle, video scrubbing and fast subclip selection. A jog dial, jog wheel, shuttle dial, or shuttle wheel is a type of knob, ring, wheel, or dial which allows the user to shuttle or jog through audio or video media. “Jog” refers to going at a very slow speed, whereas “shuttle” refers to a very fast speed. Scrubbing in video or audio files means, for example, moving a slider along the timeline back and/or forth in order to get the needed point right away, without waiting for when the video or track reaches this moment when playing at normal speed.

Consider a video being viewable on a device including a screen, such as a personal computer (PC), laptop, desktop computer, tablet computer, smartphone, mobile phone, or a smart TV, the device arranged to receive user input data, such as via a pointing device (such as a mouse), or via a touch screen interface (e.g. on a mobile phone or on a smartphone), where for example a stylus could be used as a pointing device.

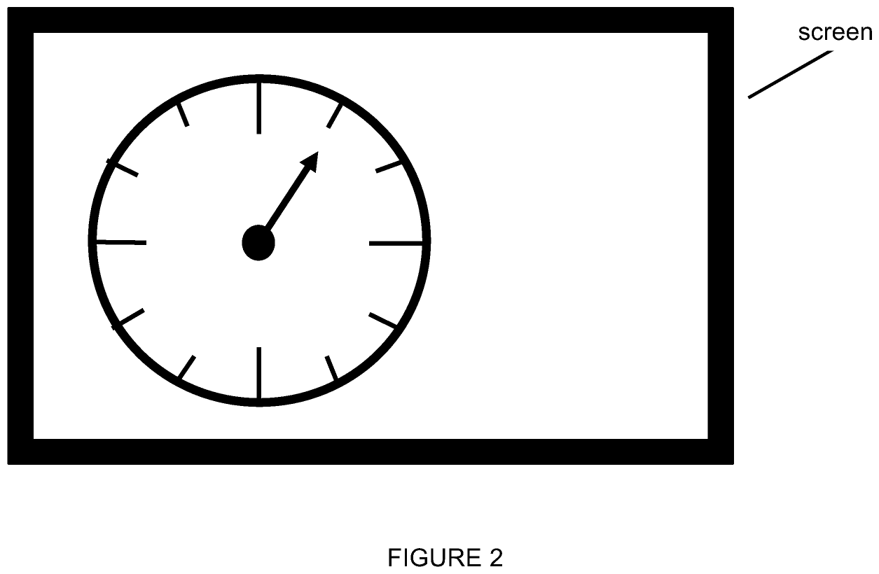

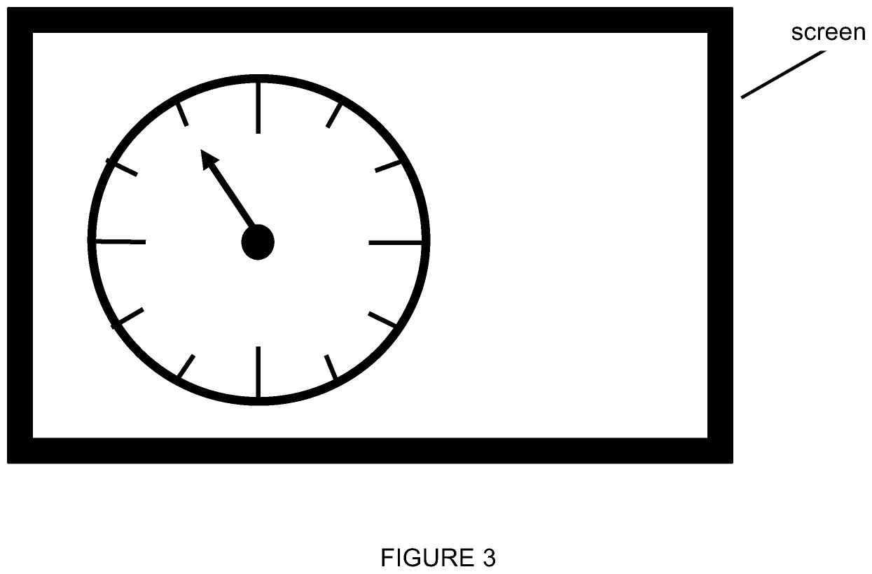

FIG. 2 and FIG. 3 represent frames of a video shown on a screen, where in this example the video is of a representation of a clock with a single hand which moves clockwise evenly through time from the first video frame on the screen shown in FIG. 2 to the final video frame on the screen shown in FIG. 3.

### Navigation

For a non-touch screen example, a pointer displayed on the screen (e.g. a cursor) can be moved by the user about the screen using a user input device, such as a mouse, without pressing any mouse buttons, or such as a keyboard (e.g. using arrow keys) or a trackpad (e.g. on a laptop). In a non-touch screen example, a pointer displayed in a window (e.g. a cursor) can be moved by the user about the window using a user input device, such as a mouse, without pressing any mouse buttons, or such as a keyboard (e.g. using arrow keys), or a trackpad (e.g. on a laptop).

In an example, when the pointer passes over the video image, the displayed frame depends on the position of the pointer (e.g. controlled by a mouse, or a keyboard, or a trackpad). When the pointer is at the far left of the screen, it is the first frame of the video (e.g. FIG. 2) that is displayed, and when the pointer is at the far right of the screen, it is the last frame of the video (e.g. FIG. 3) that is displayed. Other pointer positions intermediate to the far left of screen and to the far right of the screen correspond to frames of the video intermediate to the first frame and to the last frame. In these examples, it is the left-right distance across the screen of the pointer which controls the frame that is shown; the distance in the up-down direction on the screen of the pointer does not affect which frame is shown. In alternative examples, it is the up-down distance on the screen of the pointer which controls the frame that is shown; in these alternative examples the distance in the left-right direction on the screen of the pointer does not affect which frame is shown.

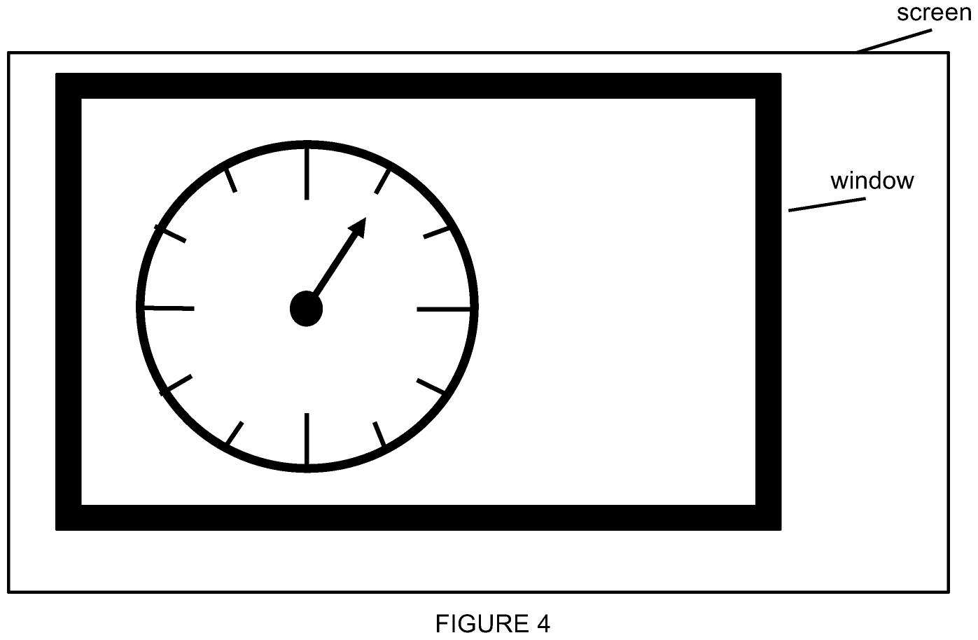

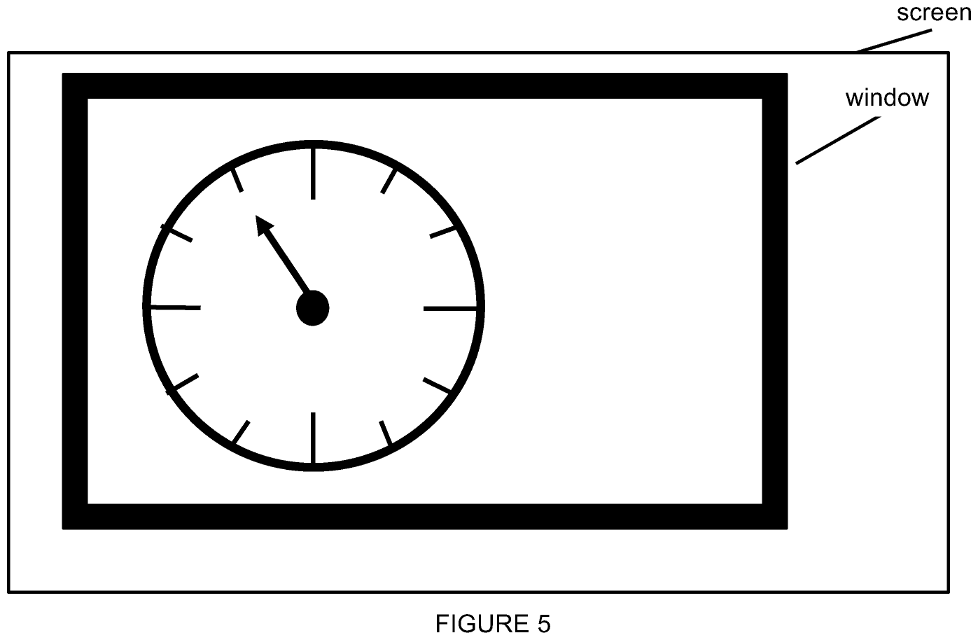

In an example, when the pointer passes over the video image, the displayed frame in a window depends on the position of the pointer (e.g. controlled by a mouse, or a keyboard, or a trackpad). When the pointer is at the far left of the window, or further than the far left of the window, it is the first frame of the video that is displayed (e.g. FIG. 4), and when the pointer is at the far right of the window, or further than the far right of the window, it is the last frame of the video that is displayed (e.g. FIG. 5). Other pointer positions intermediate to the far left of the window and to the far right of the window correspond to frames of the video intermediate to the first frame and to the last frame. In these examples, it is the left-right distance across the window of the pointer which controls the frame that is shown; the distance in the up-down direction on the window of the pointer does not affect which frame is shown. In alternative examples, it is the up-down distance on the window of the pointer which controls the frame that is shown; in these alternative examples the distance in the left-right direction on the window of the pointer does not affect which frame is shown.

In a touch screen example, we do not assume that the position of a hover above the screen is known. In this case, the displayed frame only follows the (e.g. user's or pointer) touch when the screen is touched. Analogously to the non-touch screen example, (e.g. a user or a pointer) touching the left hand edge of the screen displays the first video frame of the video and (e.g. a user or a pointer) touching the right hand edge of the screen displays the last video frame of the video. Other screen positions touched (e.g. by a user or by a pointer) intermediate to the far left of screen and to the far right of the screen result in the display of corresponding frames of the video intermediate to the first frame and to the last frame. In these examples, it is the left-right distance across the screen of the touch which controls the frame that is shown; the distance in the up-down direction on the screen of the touch does not affect which frame is shown. In alternative examples, it is the up-down distance on the screen of the touch which controls the frame that is shown; in these alternative examples the distance in the left-right direction on the screen of the touch does not affect which frame is shown.

In a touch screen example, the displayed frame in a window only follows the (e.g. user's or pointer) touch when the screen is touched. Analogously to the non-touch screen example, (e.g. a user or a pointer) touching the left hand edge of a window, or further than the far left of the window, displays the first video frame of the video and (e.g. a user or a pointer) touching the right hand edge of the window, or further than the far right of the window, displays the last video frame of the video. Other touched window positions (e.g. by a user or by a pointer) intermediate to the far left of the window and to the far right of the window result in the display of corresponding frames of the video intermediate to the first frame and to the last frame. In these examples, it is the left-right distance across the window of the touch which controls the frame that is shown; the distance in the up-down direction on the window of the touch does not affect which frame is shown. In alternative examples, it is the up-down distance on the window of the touch which controls the frame that is shown; in these alternative examples the distance in the left-right direction on the window of the touch does not affect which frame is shown.

In an example, the intermediate frame displayed corresponds to the position in time in the video which corresponds to the proportion of the pointer (or touch) position across the screen, e.g. across a horizontal dimension of the screen, or e.g. across a vertical dimension of the screen. In an example, the intermediate frame displayed in a window corresponds to the position in time in the video which corresponds to the proportion of the pointer (or touch) position across the window, e.g. across a horizontal dimension of the window, or e.g. across a vertical dimension of the window.

In another example, the displayed intermediate frames do not necessarily correspond exactly with the position of the pointer (or of the touch), e.g. to the frame most closely corresponding to the pixel position of the pointer (or of the touch). In an example, the video is compressed using a frame organisation, such as described in the section of this document “A METHOD OF COMPRESSING VIDEO DATA AND A MEDIA PLAYER FOR IMPLEMENTING THE METHOD”, and the minimum number of frames to download and decompress is calculated from the number of pixels across the video image. This is because if a higher or a substantially higher number of frames to download and decompress were used than the number of pixels across the video image, some downloaded frames would not correspond to a pixel across the video image, which would be a waste of download bandwidth and of processing resources e.g. for decompression.

For example, in an example in which the number of pixels across the image is half the number of frames in the video, only compressed video corresponding to even number frames (0, 2, 4, 6, . . . ) is downloaded and decompressed.

In an example in which the number of pixels across the image is a quarter of the number of frames in the video, only compressed video corresponding to frames which have frame numbers which are spaced by a multiple of four (e.g. 0, 4, 8, 12 . . . ) are downloaded and decompressed.

In an example in which the number of frames is 8, 16, 32 or 64 times the number of pixels across an image, only compressed video corresponding to frames which have frame numbers which are a multiple of 8, 16, 32 or 64 frames apart, respectively, are downloaded and decompressed. In the case where the number of frames is a frame chunk size multiplied by the number of pixels across the image, only compressed video corresponding to frames which have frame numbers which are a multiple of the frame chunk size of frames apart, are downloaded and decompressed.

In an example in which the number of frames corresponding to the number of pixels across the image is not a power of 2, but the number of frames is greater than the number of pixels across the image, only enough frames are downloaded to allow every pixel across the image, which is a possible position of the pointer, to correspond to a different frame: this minimizes the downloads whilst maintaining the precision of the navigation when selecting frames.

Previously displayed frames can be cached, e.g. at the displaying device, to provide a more responsive experience for the user moving the input selection (e.g. a pointer, or a touch position) across the display.

The above provides a very simple, intuitive, discoverable and fast video navigation tool.

The above may be provided for a screen that is viewed in landscape mode, as would typically be the case for a desktop computer, a laptop computer, a smart TV or a tablet computer. The above may be provided for a screen that is viewed in portrait mode, as would typically be the case for a smartphone.

### Clipping

One key objective of a video editing workflow is to work through potentially large amounts of source content and pick out the best parts, e.g. the gems.

Finding the best frame is possible using a navigation method described above. To select a subset of this video content, for example the user provides input such as moving a pointer displayed on the screen to display the relevant first frame and makes a selection (e.g. by pressing down a mouse button or similar) to mark one end of the portion of the video to be selected. Then the user provides input such as moving the pointer displayed on the screen (e.g. using a mouse) to the other end of the portion of the video to be selected, and makes a selection, e.g. by releasing the mouse. As a result, a portion of the video is selected. The selected portion of the video may be saved automatically. The selected portion of the video may be saved automatically, using an automatically generated filename. The selected portion of the video may be offered for saving, using a filename received from user input.

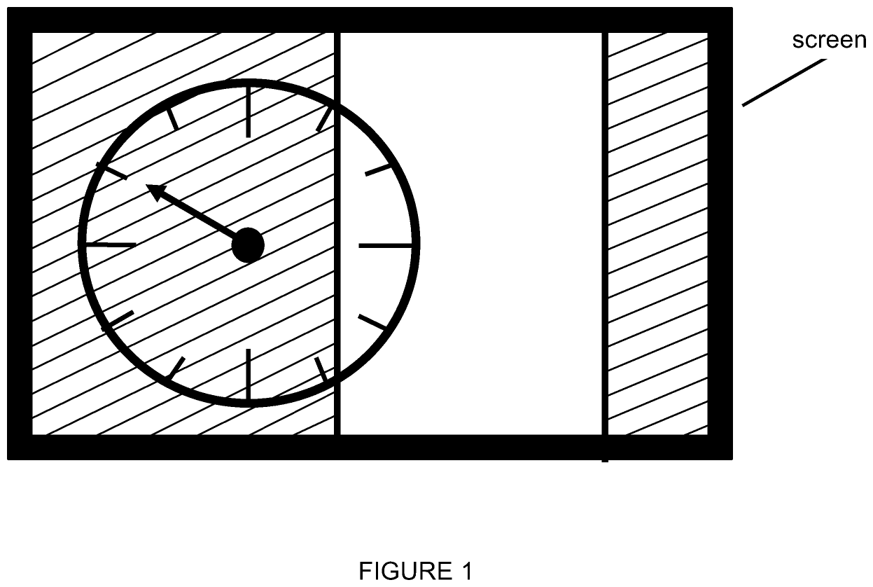

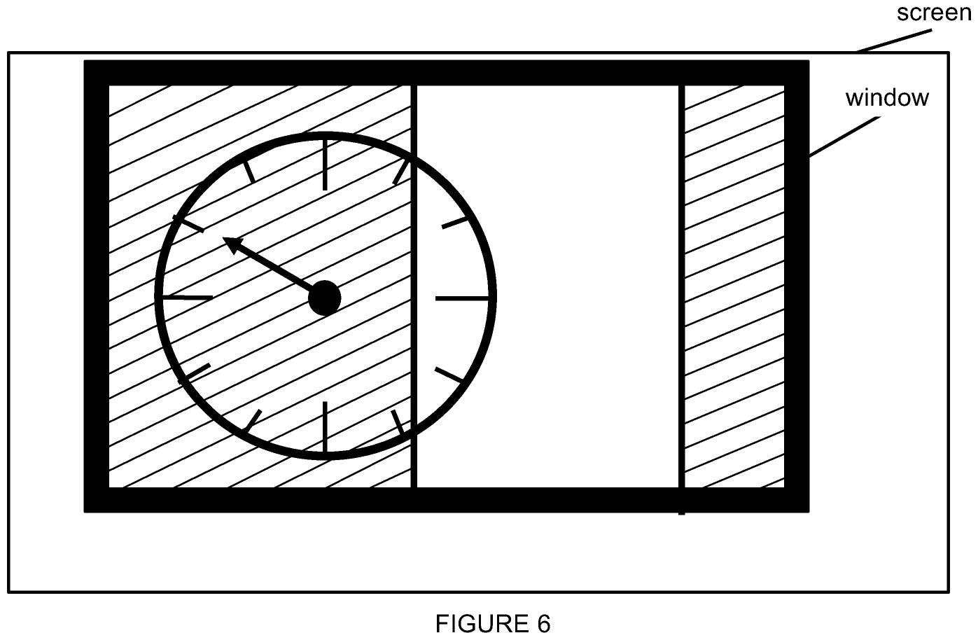

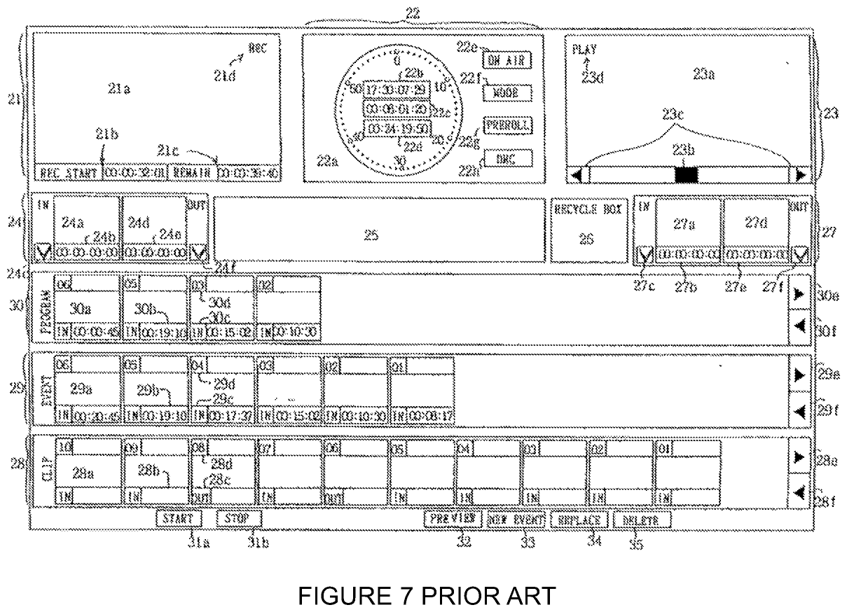

In an example, as a user provides input, for example as the user moves the pointer displayed on the screen, e.g. by dragging e.g. using a mouse, the growing selected region may be highlighted compared to the non-selected region, e.g. by dimming the portion of the image which corresponds to the non-selected portion of the video, marking out an area. In an example, the non-shaded part of the image on a screen corresponds to the selected time interval of the video, represented in the horizontal dimension of the image on the screen. An example is shown in FIG. 1. In an example, the non-shaded part of the image in a window on a screen corresponds to the selected time interval of the video, represented in the horizontal dimension of the image in the window on the screen. An example is shown in FIG. 6. A selection, eg. a mouse button release, or similar, completes the selection of a portion of the video content. So for example, if the image shown on the screen (or in a window on the screen) is not shaded, in the horizontal dimension, from the middle to three quarters of the distance from the left hand side to the right hand side of the image (or in the window on the screen), and is shaded elsewhere, then the selected portion of the video is from the middle of the duration of the video to three quarters of the duration of the video. This is because in this example the non-shaded part of the image (or in the window on the screen) corresponds to the selected time interval of the video, represented in the horizontal dimension of the image (or in the window on the screen).

The start and end points of the portion of the video may be selectable in either order. The end point is defined by the later point in time in the video, and the start point is defined by the earlier point in time in the video. So for example, in a one minute video, if the points 15 seconds and 25 seconds from the start of the video are selected in this order, then the point 15 seconds from the start of the video defines the start point of the portion and the point 25 seconds from the start of the video defines the end point of the portion. And for example if the points 45 seconds and 35 seconds from the start of the video are selected in this order, then the point 35 seconds from the start of the video defines the start point of the portion and the point 45 seconds from the start of the video defines the end point of the portion. The start point is determined as the earlier of the two selected points, and the end point is determined as the later of the two selected points.

In one example, the selected portion of the video content is appended into a video window, where one or more clips can be collected to form a video that is a composite of selected portions of the video content. When the video that is a composite of selected portions of the video content is completed, the video that is a composite of selected portions of the video content may be stored.

In another example, the clip is sent to Social media such as Instagram or TikTok (possibly via a pop up window which may be used to fill in any text description or hashtags, or the like).

In another example, a mouse click starts the selection of a portion of the video and another mouse click ends the selection of a portion of the video, for example with the left mouse button starting the selection of a portion of the video and the right mouse button ending the selection of a portion of the video, or one mouse button performing most functions, such as starting the selection of a portion of the video and ending the selection of a portion of the video.

In an example, the selected start and end points of the selected portion of the video may be shown on the video displaying application, as well as the length of the selected clips.

A method for clearing the selection is also provided. For example a “clear selection” selectable icon is provided in the user interface.

Multiple selections of video portions may be made from the same source video. The multiple selections may be respectively presented in distinct ways in the user interface. For example, differently shaded parts of the image may correspond to different selected time intervals of the video, represented in the horizontal dimension of the image.

In an example, on a touch screen device, a long duration press (e.g. at least two seconds) is used to confirm the initiation of a selection of start frame of the video, and the selection of a portion of the video, and the two ends of the clip may be marked by navigating as described above, e.g. by sliding a finger across the screen, and then releasing to define the end frame of the portion of the video. In an alternative, the selection process may continue such that a further long press (e.g. at least two seconds) indicates the end of the selection, to define the end frame of the portion of the video.

In another example, on a touch screen device, the selection is completed by relinquishing the connection to the screen (for example as inferred by the device by no touch having been received by the device in a predefined time interval such as four seconds), and the final selected frame marks the end of the selected portion of the video.

### Examples of Clip Creation System

The above methods of editing a video to create a clip video which includes one or more portions of an original video, may be provided in a web browser interface, the web browser running on a computing device, such as a smartphone, a desktop computer, a tablet computer, a laptop computer, or a smart TV. The video file that is being edited may be locally stored on the computing device. The video file that is being edited may be stored on a server in communication with the computing device. The edited video file may be locally stored on the computing device. The edited video file may be stored on a server in communication with the computing device.

The above methods of editing a video to create a clip video which includes one or more portions of an original video, may be provided in an app downloadable to a computing device, the app executable on the computing device, such as a smartphone, a desktop computer, a tablet computer, a laptop computer, or a smart TV. The video file that is being edited may be locally stored on the computing device. The video file that is being edited may be stored on a server in communication with the computing device. The edited video file may be locally stored on the computing device. The edited video file may be stored on a server in communication with the computing device.

### Video Navigation Tool

A video navigation tool (eg. Blackbird Waveform) may be provided. An example of such a video navigation tool is provided in the “A Method for Enabling Efficient Navigation of Video” section of this document.

As part of video content ingestion, in an example we prepare the navigation tool (e.g. as disclosed in the “A Method for Enabling Efficient Navigation of Video” section of this document) in association with the ingested video content.

The video navigation tool may represent a précis of the video and optionally audio in the content. This can be used to help the editor refine the start and end points of a selected portion of the video, to make them frame accurate, with the inclusion of trim buttons for the In point and Out point.

Moving a cursor on the screen, orthogonally to the length of the video navigation tool, may decrease locally in the video navigation tool the number of frames represented locally in the navigation tool, i.e. decrease the number of frames represented in the navigation tool per unit distance along the navigation tool. This may facilitate selection of an individual frame. The video navigation tool can optionally indicate the position of a current frame in the video. The full length of the video navigation tool from the left to the right on the screen includes and corresponds roughly to the number of frames selectable in the video clipping tool described above.

### Audio

In digital audio editing, scrubbing is an interaction in which a user drags a cursor or playhead across a segment of a waveform to hear it. In an implementation of the system or method, audio scrubbing is available during navigation-that is the audio is represented aurally during navigation when the pointer moves through the video.

### Note

Any combination of the above described features may be included in different implementations, as would be understood by the skilled person.

### A Method of Compressing Video Data and a Media Player for Implementing The Method

This section of this document relates to disclosures made in WO2007077447A2 and U.S. Pat. No. 8,660,181B2.

There is provided a method of receiving video data comprising the steps of: receiving at least one chunk of video data comprising a number of sequential key video frames where the number is at least two and, constructing at least one delta frame between a nearest preceding key frame and a nearest subsequent key frame from data contained in the either or each of the nearest preceding and subsequent frames.

Visual recordings of moving things are generally made up of sequences of successive images. Each such image represents a scene at a different time or range of times. This disclosure relates to such sequences of images such as are found, for example, in video, film and animation.

Video takes a large amount of memory, even when compressed. The result is that video is generally stored remotely from the main memory of the computer. In traditional video editing systems, this would be on hard discs or removable disc storage, which are generally fast enough to access the video at full quality and frame rate. Some people would like to access and edit video files content remotely, over the internet, in real time. This disclosure relates to the applications of video editing (important as much video content on the web will have been edited to some extent), video streaming, and video on demand.

At present any media player editor implementing a method of transferring video data across the internet in real time suffers the technical problems that: (a) the internet connection speed available to internet users is, from moment to moment, variable and unpredictable; and (b) that the central processing unit (CPU) speed available to internet users is from moment to moment variable and unpredictable.

For the application of video editing, consistent image quality is very preferable, because many editing decisions are based on aspects of the image, for example, whether the image was taken in focus or out.

It is an object of the present disclosure to alleviate at least some of the aforementioned technical problems. Accordingly this disclosure provides a method of receiving video data comprising the steps of: receiving at least one chunk of video data comprising a number (n) of sequential key video frames where the number (n) is at least two and, constructing at least one delta frame between a nearest preceding key frame and a nearest subsequent key frame from data contained in either, or each, of the nearest preceding and subsequent frames.

Preferably the delta frame is composed of a plurality of component blocks or pixels and each component of the delta frame is constructed according to data indicating it is one of: the same as the corresponding component in the nearest preceding key frame, or the same as the corresponding component in the nearest subsequent key frame, or a new value compressed using some or all of the spatial compression of the delta frame and information from the nearest preceding and subsequent frames. After the step of construction, the delta frame may be treated as a key frame for the construction of one or more further delta frames. Delta frames may continue to be constructed in a chunk until either: a sufficiently good predetermined image playback quality criterion is met or the time constraints of playing the video in real time require the frames to be displayed. The number of key frames in a chunk may be in the range from n=3 to n=10.

Although the method may have other applications, it is particularly advantageous when the video data is downloaded across the internet. In such a case it is convenient to download each key frame in a separate download slot, the number of said download slots equating to the maximum number of download slots supportable by the internet connection at any moment in time. Preferably each slot is implemented in a separate thread. Where it is desired to subsequently edit the video it is preferable that each frame, particularly the key frames, are cached upon first viewing to enable subsequent video editing.

According to another aspect of this disclosure, there is provided a media player arranged to implement the method which preferably comprises a receiver to receive chunks of video data including at least two key frames, and a processor adapted to construct a delta frame sequentially between a nearest preceding key frame and a nearest subsequent key frame. Preferably, a memory is also provided for caching frames as they are first viewed to reduce the subsequent requirements for downloading.

According to a third aspect of this disclosure, there is provided a method of compressing video data so that the video can be streamed across a limited bandwidth connection with no loss of quality on displayed frames which entails storing video frames at various temporal resolutions which can be accessed in a pre-defined order, stopping at any point. Thus multiple simultaneous internet accesses can ensure a fairly stable frame rate over a connection by (within the resolution of the multitasking nature of the machine) simultaneously loading the first or subsequent temporal resolution groups of frames from each of a number of non-intersecting subsets of consecutive video frames until either all the frames in the group are downloaded, or there would probably not be time to download the group, in which case a new group is started.

This disclosure includes a method for enabling accurate editing decisions to be made over a wide range of internet connection speeds, as well as video playback which uses available bandwidth efficiently to give a better experience to users with higher bandwidth. Traditional systems have a constant frame rate, but the present disclosure relates to improving quality by adding extra delta frame data, where bandwidth allows.

A source which contains images making up a video, film, animation or other moving picture is available for the delivery of video over the internet. Images (2, 4, 6 . . . ) in the source are digitised and labelled with frame numbers (starting from zero) where later times correspond to bigger frame numbers and consecutive frames have consecutive frame numbers. The video also has audio content, which is split into sections.

The video frames are split into chunks as follows: A value of n is chosen to be a small integer 0≤n. In one implementation, n is chosen to be 5. A chunk is a set of consecutive frames of length 2^n. All frames appear in at least one chunk, and the end of each chunk is always followed immediately by the beginning of another chunk.

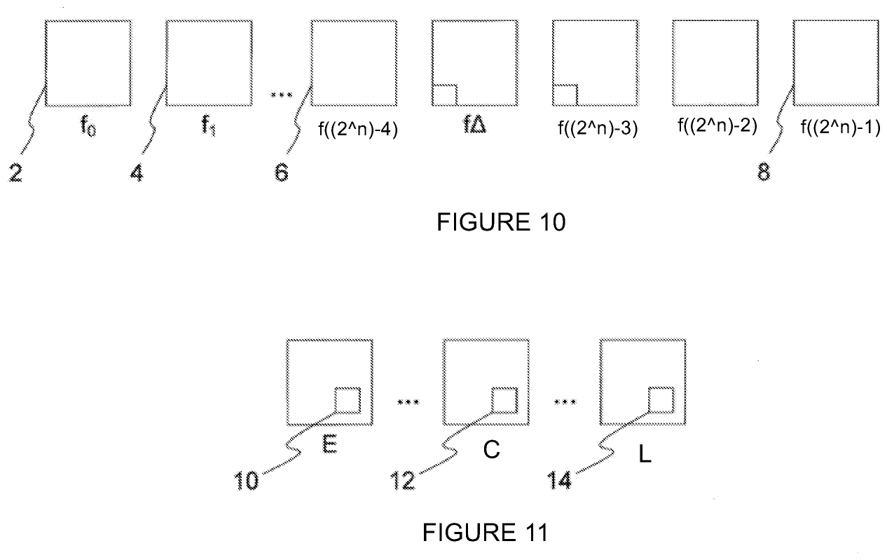

“f” represent the frame number in the chunk, where the earliest frame (2) in each chunk has f=0, and the last (8) has f=(2^n)−1 (see e.g. FIG. 10).

All f=0 frames in a chunk are compressed as key frames-that is they can be recreated without using data from any other frames. All frames equidistant in time between previously compressed frames are compressed as delta frames recursively as follows: Let frame C (see e.g. FIG. 11) be the delta frame being compressed. Then there is a nearest key frame earlier than this frame, and a nearest key frame later than this frame, which have already been compressed. Let us call them E and L respectively. Each frame is converted into a spatially compressed representation, in one implementation comprising rectangular blocks of various sizes with four Y or UV values representing the four corner values of each block in the luminance and chrominance respectively.

Frame C is compressed as a delta frame using information from frames E and L (which are known to the decompressor), as well as information as it becomes available about frame C.

In one implementation, the delta frame is reconstructed as follows:

Each component (12) of the image (pixel or block) is represented as either: the same as the corresponding component (10) in frame E; or the same as the corresponding component (14) in frame L; or a new value compressed using some or all of spatial compression of frame C, and information from frames E and L.

Compressing the video data in this way allows the second part of the disclosure to function. This is described next. When transferring data across the internet, using the HTTP protocol used by web browsers, the described compression has advantages, for example enabling access through many firewalls. The two significant factors relevant to this disclosure are latency and bandwidth. The latency here is the time taken between asking for the data and it starting to arrive. The bandwidth here is the speed at which data arrives once it has started arriving. For a typical domestic broadband connection, the latency can be expected to be between 20 ms and 1 s, and the bandwidth can be expected to be between 256 kb/s and 8 Mb/s.

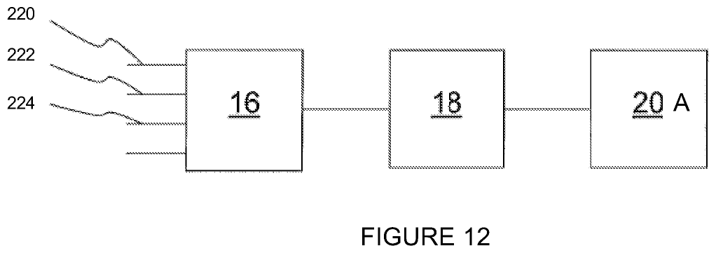

The disclosure involves one compression step for all supported bandwidths of connection, so the player (e.g. 16, FIG. 12) has to determine the data to request which gives the best playback experience. This may be done as follows:

The player has a number of download slots (220, 222, 224 . . . ) for performing overlapping downloads, each running effectively simultaneously with the others. At any time, any of these may be blocked by waiting for the latency or by lost packets.

Each download slot is used to download a key frame, and then subsequent files (if there is time) at each successive granularity. When all files pertaining to a particular section are downloaded, or when there would not be time to download a section before it is needed for decompression by the processor (18), the download slot is applied to the next unaccounted for key frame.

In one implementation of the disclosure, each slot is implemented in a separate thread.

A fast link results in all frames being downloaded, but slower links download a variable frame rate at e.g. 1, ½, ¼, ⅛ etc of the frame rate of the original source video for each chunk. This way the video can play back with in real time at full quality, possibly with some sections of the video at lower frame rate.

In a further implementation, as used for video editing, frames downloaded in this way are cached in a memory (20A) when they are first seen, so that on subsequent accesses, only the finer granularity videos need be downloaded.

The number of slots depends on the latency and the bandwidth and the size of each file, but is chosen to be the smallest number which ensures the internet connection is fully busy substantially all of the time.

In one implementation, when choosing what order to download or access the data in, the audio is given highest priority (with earlier audio having priority over later audio), then the key frames, and then the delta frames (within each chunk) in the order required for decompression with the earliest first.

There is provided a method of receiving video data comprising the steps of: receiving at least one chunk of video data comprising a number (n) of sequential key video frames where the number (n) is at least two and, constructing at least one delta frame (C) between a nearest preceding key frame (E) and a nearest subsequent key frame (L) from data contained in the either or each of the nearest preceding and subsequent frames.

The method may be one wherein the delta frame (C) is composed of a plurality of component blocks or pixels and each component of the delta frame is constructed according to data indicating it is one of:
(a) the same as the corresponding component in the nearest preceding key frame (E), or
(b) the same as the corresponding component in the nearest subsequent key frame (L),
or (c) a new value compressed using some or all of the spatial compression of frame C, and information from the nearest preceding and subsequent frames.

The method may be one wherein after the step of construction, the delta frame is treated as a key frame for the construction of one or more delta frames.

The method may be one wherein delta frames continue to be constructed in a chunk until either: a sufficiently good predetermined image playback quality criterion is met or the time constraints of playing the video in real time require the frames to be displayed.

The method may be one wherein the number of key frames is in the range from n=3 to n=10.

The method may be one comprising downloading the video data across the internet.

The method may be one comprising downloading each key frame in a separate download slot, the number of said download slots equating to the maximum number of download slots supportable by the internet connection at any moment in time.

The method may be one wherein each slot is implemented in a separate thread.

The method may be one wherein each frame is cached upon first viewing to enable subsequent video editing.

The method may be one wherein the key frames are cached.

There is provided a media player configured to implement the method according to any one of the above statements.

The media player may be one having: a receiver to receive chunks of video data including at least two key frames, a processor adapted to construct a delta frame sequentially between a nearest preceding key frame and a nearest subsequent key frame.

There is provided a method of compressing video data so that the video can be streamed across a limited bandwidth connection with no loss of quality on displayed frames, the method comprising storing video frames at various temporal resolutions which can be accessed in a pre-defined order, stopping at any point.

The method may be one where multiple simultaneous internet accesses can ensure a fairly stable frame rate over a connection by simultaneously loading the first or subsequent temporal resolution groups of frames from each of a number of non-intersecting subsets of consecutive video frames until either all the frames in the group are downloaded, or until a predetermined time has elapsed, and then in starting a new group.

There is provided a method of compressing video data with no loss of frame image quality on the displayed frames, by varying the frame rate relative to the original source video, the method comprising the steps of:
receiving at least two chunks of uncompressed video data, each chunk comprising at least two sequential video frames and,
compressing at least one frame in each chunk as a key frame, for reconstruction without the need for data from any other frames,
compressing at least one intermediate frame as a delta frame between a nearest preceding key frame and a nearest subsequent key frame from data contained in either or each of the nearest preceding and subsequent frames,
wherein further intermediate frames are compressed as further delta frames within the same chunk, by treating any previously compressed delta frame as a key frame for constructing said further delta frames, and
storing the compressed video frames at various mutually exclusive temporal resolutions, which are accessed in a pre-defined order, in use, starting with key frames,
and followed by each successive granularity of delta frames, stopping at any point; and whereby the frame rate is progressively increased as more intermediate data is accessed.

The method may be one wherein the delta frame is composed of a plurality of component blocks or pixels and each component of the delta frame is constructed according to data indicating it is one of:
(a) the same as the corresponding component in the nearest preceding key frame, or
(b) the same as the corresponding component in the nearest subsequent key frame, or
(c) a new value compressed using some or all of the spatial compression of frame, and information from the nearest preceding and subsequent frames.

The method may be one wherein after the step of construction, the delta frame is treated as a key frame for the construction of one or more delta frames.

The method may be one wherein delta frames continue to be constructed in a chunk until either: a predetermined image playback quality criterion, including a frame rate required by an end-user, is met or the time constraints of playing the video in real time require the frame to be displayed.

The method may be one wherein the number of frames in a chunk is 2^n, and n is in the range from n=3 to n=10.

The method may be one comprising downloading the video data across the internet.

The method may be one comprising downloading each key frame in a separate download slot, the number of said download slots equating to the minimum number to fully utilize the internet connection.

The method may be one wherein each slot is implemented in a separate thread.

The method may be one wherein each frame is cached upon first viewing to enable subsequent video editing.

The method may be one wherein the key frames are cached.

There is provided a method of processing video data comprising the steps of:
receiving at least one chunk of video data comprising 2^n frames and one key video frame, and the next key video frame;
constructing a delta frame (C) equidistant between a nearest preceding key frame (E) and a nearest subsequent key frame (L) from data that includes data contained in either or each of the nearest preceding and subsequent key frames;
constructing additional delta frames equidistant between a nearest preceding key frame and a nearest subsequent key frame from data that includes data contained in either or each of the nearest preceding and subsequent key frames, wherein at least one of the nearest preceding key frame or the nearest subsequent key frame is any previously constructed delta frame; storing the additional delta frames at various mutually exclusive temporal resolutions, which are accessible in a pre-defined order, in use, starting with the key frames, and followed by each successive granularity of delta frames, stopping at any point; and continuing to construct the additional delta frames in a chunk until either a predetermined image playback quality criterion, including a user selected frame rate, is achieved, or a time constraint associated with playing of the chunk of video data in real time requires the frames to be displayed.

The method may be one further comprising downloading the at least one chunk of video data at a frame rate that is less than an original frame rate associated with the received video data.

The method may be one further comprising determining a speed associated with the receipt of the at least one image chunk, and only displaying a plurality of constructed frames in accordance with the time constraint and the determined speed.

### A Method for Enabling Efficient Navigation of Video

This section of this document relates to disclosures made in EP1738365B1, WO2005101408A1 and U.S. Pat. No. 8,255,802B2.

A method is provided of facilitating navigation of a sequence of source images, the method using tokens representing each source image which are scaled versions of each source image and which are arranged adjacently on a display device in a continuous band of token images so that a pointer device can point to a token and the identity of the corresponding image is available for further processing.

Visual recordings of moving things are generally made up of sequences of successive images. Each such image represents a scene at a different time or range of times. This disclosure relates to recordings including sequences of images such as are found, for example, in video, film and animation.

The common video standard PAL used in Europe comprises 25 frames per second. This implies that an hour of video will include nearly 100,000 frames. Other video formats, such as the NTSC standard used in the USA and Japan, have similar number of frames per hour as PAL.

A requirement for a human operator to locate accurately and to access reliably a particular frame from within many can arise. One application where this requirement arises is video editing. In this case, the need may not just be for accurate access on the scale of individual frames, but also easy access to different scenes many frames apart. In other words, there is a need to be able to access video frames over a range of time scales which may be up to five or six orders of magnitude apart.

The disclosure provided herein includes a method for enabling efficient access to video content over a range of temporal scales.

Assume there is a source which contains images making up a video, film, animation or other moving picture. Images in the source are digitised and labelled with frame numbers where later times correspond to bigger frame numbers and consecutive frames have consecutive frame numbers.

Each image is given an associated token image, which may be a copy of the source image. In practice, these source images may be too big to fit many on a display device such as a computer screen, a smartphone screen, or a tablet screen, at the same time. In this case, the token image will be a reduced size version of the original image. The token images are small enough that a number of token images can be displayed on the display device at the same time. In an application according to this disclosure, this size reduction is achieved by averaging a number of pixels in the source image to give each corresponding pixel in the smaller token images. There are many tools available to achieve this. In this application, there are typically between ten and fifty token images visible at a time.

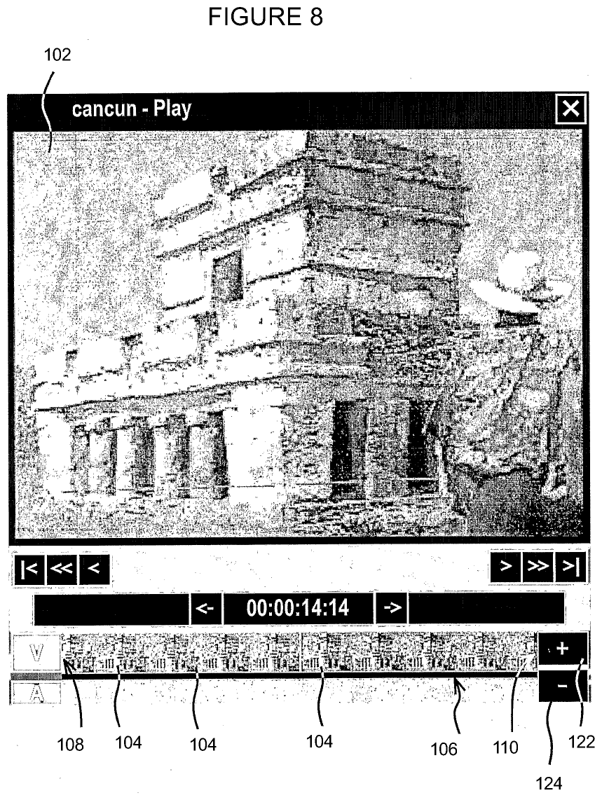

Referring to FIG. 8, in an example, there is provided a computer display whose resolution is 1024×768 pixels, and the images (102) from the source video are digitised at 320×240 pixels, and the tokens (104) representing the source images are 32×24 pixels. In one commercial application, the token images have the same aspect ratio as the original images.

The token images are then combined consecutively with no gaps between them in a continuous band (106) which is preferably horizontal. This band is then displayed on the computer screen, although if the source is more than a few images in length, the band will be wider than the available display area, and only a subset of it will be visible at any one time.

The video is navigated to frame accuracy by using a pointing device, such as a mouse, which is pointed at a particular token within the horizontal band. This causes the original image corresponding to this token to be selected. Any appropriate action can then be carried out on the selected frame. For example, the selected frame can then be displayed. In another example, the time code of the selected frame can be passed on for further processing. In a further example, the image pixels of the selected frame can be passed on for further processing.

In a further refinement, in one implementation, when the pointing device points near to the edge (108) or (110) of the displayed subset of the horizontal band, the band automatically and smoothly scrolls so that the token originally being pointed to moves towards the centre of the displayed range. This allows access beyond the original displayed area of the horizontal band.

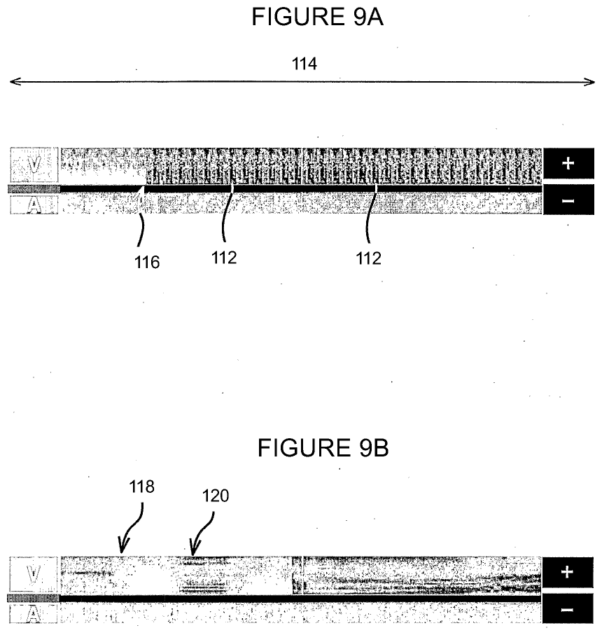

The above description therefore shows how frame accurate access is simple for short clips. The same principle can be extended to longer sequences of source image frames, as illustrated for example in FIG. 9A.

Each token is reduced in size, but this time only horizontally. This reduction leaves each new token (112) at least one pixel wide. Where the reduction in size is by a factor of x, the resulting token is called an x-token within this document. So, for example, 2-tokens are half the width of tokens, but the same height. The x-tokens are then displayed adjacent to each other in the same order as the original image frames to create a horizontal band as with the tokens, but with the difference that more of these x-tokens fit in the same space than the corresponding tokens, by a factor of x.

Navigation proceeds as before, the difference being that each x-token is narrower than before, so that more of them are visible than with the original tokens, and a smaller pointer movement is needed to achieve the same movement in frames.

In one such implementation, the space (114) allocated to the horizontal band for tokens and x-tokens is 320 pixels. The tokens (104) are 32×24 pixels, and the x-tokens (112) are created in a variety of sizes down to 1×24 pixels. In the 32-token case, the horizontal band corresponds to 320 frames of video, compared with ten frames for the token image. This range of 320 frames can be navigated successfully with the pointer.

This design is a significant departure from existing commercial systems where instead of a horizontal band made of all the x-tokens, the corresponding band may contain one token in every x. In this disclosure, subject to the colour resolution of the display device, every pixel in every image contributes some information to each horizontal band. Even with x-tokens only one pixel wide, the position of any cut (116) on the source is visible to frame accuracy, as are sudden changes in the video content.

The x-tokens are fine for navigating short clips, but to navigate longer sources, further horizontal reductions are required, see e.g. FIG. 9B. In the case where each horizontal pixel on the horizontal display band represents y frames, the horizontal band made of 1 pixel wide x-tokens is squashed horizontally by a factor of y. If y is an integer, this is achieved by combining y adjacent non-intersecting sets of 1 pixel wide x-tokens (by for example averaging) to make a y-token one pixel wide and the same height as the tokens. Significant changes of video content (118, 120) can still be identified, even for quite large values of y.

In one implementation, values of x and y used are powers of two, and the resulting horizontal display bands represent all scales from 0 frames to 5120 frames. Larger values of y will be appropriate for longer videos.

In the x-tokens and y-tokens, the values of x and y need not be integers, although appropriate weightings between vertical lines within image frames and between image frames will then be needed if image artefacts are to be avoided.

In one implementation, the tokens, x-tokens and y-tokens are created in advance of their use for editing in order to facilitate rapid access to the horizontal bands. The x-tokens and y-tokens are created at multiple resolutions. Switching between horizontal bands representing different scales is facilitated by zoom in and zoom out buttons (122, 124) which move through the range of horizontal contractions available.

There is provided a method of facilitating navigation of a sequence of source images, the method using tokens representing each source image which are scaled versions of each source image and which are arranged adjacently on a display device in a continuous band of token images so that a pointer device can point to a token and the identity of the corresponding image is available for further processing.

The method may be one where one or more new bands can be constructed by squashing the band in the longitudinal direction by one or more factors in each case squashing by a factor which is no wider than the pixel width of the individual tokens making up the band.

The method may be one where neighbouring tokens are first combined to make new tokens corresponding to multiple frames and these new tokens are arranged next to each other in a band. The method may be one where the widths and heights of different tokens differ. The method may be one in which the band is arranged horizontally on a display device together with a normal video display generated from the source images. The method may be one which is so arranged that, when the pointer device points to a token near to the edge of the displayed subset of the continuous band, the band automatically scrolls, so that the token moves towards the centre of the displayed range, thereby allowing access to a region beyond the original displayed area.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A computer-implemented method of editing a video file, the method including the steps of:
(i) receiving a selection of a video file to edit, the video file including a duration;
(ii) presenting a frame of the video file (e.g. a first frame of the video file) on a screen of a computing device, the computing device including the screen;
(iii) the computing device receiving an input corresponding to a position on the presented frame of the video file on the screen of the device, the input comprising a width coordinate and a height coordinate;
(iv) presenting a frame of the video file on the screen of the computing device, the presented frame being a frame at a time in the video file that corresponds to the width coordinate as a proportion of the width of the presented frame on the screen, or to the height coordinate as a proportion of the height of the presented frame on the screen, of the duration of the video file, from the start of the video file;
(v) repeating steps (iii) and (iv) until an input is received by the computing device identifying the presented frame as a start frame of a portion of the video file;
(vi) repeating steps (iii) and (iv) until an input is received by the computing device identifying the presented frame as an end frame of the portion of the video file;
(vii) saving the portion of the video file that is defined by the start frame of the portion of the video file received in step (v) and the end frame of the portion of the video file received in step (vi).

2. The method of claim 1, wherein the computing device is a PC, laptop, desktop computer, tablet computer, smartphone, mobile phone, or a smart TV.

3. The method of claim 1,
(a) wherein the screen area includes four edges, wherein the frame of the video file presented on the screen of the computing device includes edges which coincide with the four edges of the screen area; or
(b) wherein the screen area includes four edges, wherein the frame of the video file presented on the screen of the computing device is presented over the whole of the screen area.

4-6. (canceled)

7. The method of claim 1, wherein the input received by the computing device corresponding to the position on the presented frame of the video file on the screen of the device is the position of a pointer (e.g. a cursor) displayed on the screen, the input comprising a width coordinate and a height coordinate, wherein the position of the pointed (e.g. a cursor) displayed on the screen is movable using a user input device, such as a mouse (e.g. without pressing any mouse buttons), or such as a keyboard (e.g. using arrow keys) or a trackpad (e.g. on a laptop).

8. (canceled)

9. The method of claim 7,
(a) wherein when the pointer is further left than the far left of the window, it is the first frame of the video that is displayed; or
(b) wherein when the pointer is further right than the far right of the window, it is the last frame of the video that is displayed; or
(c) wherein when the pointer is further up than the top of the window, it is the first frame of the video that is displayed; or
(d) wherein when the pointer is further down than the bottom of the window, it is the last from of the video that is displayed.

10-12. (canceled)

13. The method of any previous claim 1,
(a) wherein the input received by the computing device identifying the presented frame as the start frame of the portion of the video file includes a pressing down of a mouse button, and where the input received by the computing device identifying the presented frame as the end from of the portion of the video file includes a release of the previously pressed down mouse button; or
(b) wherein the input received by the computing device identifying the presented frame as the start frame of the portion of the video file includes a pressing down of a mouse button, and where the input received by the computing device identifying the presented frame as the end frame of the portion of the video file includes a press of a different button of the mouse.

14-15. (canceled)

16. The method of claim 1, wherein the input received by the computing device identifying the presented frame as the start frame of the portion of the video file includes a mouse click, and the input received by the computing device identifying the presented frame as the end frame of the portion of the video file includes a further mouse click.

17. The method of claim 1, wherein the computing device is arranged to receive user input via a touch screen interface, wherein the input received by the computing device corresponding to the position on the presented frame of the video file on the screen of the device, the input comprising a width coordinate and a height coordinate, is the position of a touch on the screen.

18. (canceled)

19. The method of claim 17,
(a) wherein when the position of the touch on the screen is further left than the far left of the window, it is the first frame of the video that is displayed; or
(b) wherein when the position of the touch on the screen is further right than the far right of the window, it is the last frame of the video that is displayed; or
(c) wherein when the position of the touch on the screen is further up than the top of the window, it is the first frame of the video that is displayed; or
(d) wherein when the position of the touch on the screen is further down than the bottom of the window, it is the last frame of the video that is displayed.

20-22. (canceled)

23. The method of claim 17,
(a) wherein a long duration press (e.g. at least two seconds) is used to confirm the initiation of a selection of the start frame of the video, and the selection of a portion of the video, and the two ends of the clip may be marked by detecting a sliding a finger across the screen, and the detecting a finger release from the screen to define the end frame of the portion of the video; or
(b) wherein a long duration press (e.g. at least two seconds) is used to confirm the initiation of a selection of the start frame of the video, and a further long press (e.g. at least two seconds) indicates the end of the selection, to define the end frame of the portion of the video.

24-27. (canceled)

28. The method of claim 1, wherein the video file is stored in a compressed format structure on a server, and wherein the video file is stored in the compressed format structure on the server, the compressed format structure including a hierarchy of levels of temporal resolution of frames, each respective level of the hierarchy including frames corresponding to a respective temporal resolution of the respective level of the hierarchy, but not including frames which are included in one or more lower levels of lower temporal resolution of frames of the hierarchy.

29. (canceled)

30. The method of claim 28, wherein the minimum number of frames to download to the computing device and decompress is calculated from the number of pixels horizontally or vertically across the video image, and wherein only enough frames are downloaded to allow every pixel across the image, which is a possible position of the pointer or touch, to correspond to a different frame.

31-37. (canceled)

38. The method of claim 1, wherein the saved portion of the video file is sendable to social media such as Instagram or TikTok, possibly via a pop up window which may be used to fill in any text description or hashtags, or the like.

39. The method of claim 1,
(a) wherein the method includes highlighting a portion of the width of the presented frame corresponding to the portion of video between the start frame identified in step (v) and the width coordinate of the input in step (iii) corresponding to the position on the presented frame of the video file on the screen of the device; or
(b) wherein the method includes highlighting a portion of the height of the presented frame corresponding to the portion of video between the start frame identified in step (v) and the height coordinate of the input in step (iii) corresponding to the position on the presented frame of the video file on the screen of the device.

40-42. (canceled)

43. The method of any previous claim 1, wherein the start and end points of the portion of the video are selectable in either order, and wherein the start point is determined as the earlier of the two selected points in steps (v) and (vi), and the end point is determined as the later of the two selected points in steps (v) and (vi).

44. (canceled)

45. The method of any previous claim 1, wherein a selected portion of the video content is appended into a video window, where one or more clips are collectable in the video window to form a video that is a composite of selected portions of the video content.

46. The method of claim 45, wherein the video that is a composite of the selected portions of the video content is stored in response to receiving a user command, and wherein the stored video that is a composite of the selected portions of the video content is sent to social media.

47. (canceled)

48. The method of claim 1, wherein the method of editing a video to create a clip video which includes one or more portions of an original video, is provided in a web browser interface, the web browser running on a computing device such as a smartphone, a desktop computer, a tablet computer, a laptop computer, or a smart TV.

49. The method of claim 1, wherein the method of editing a video to create a clip video which includes one or more portions of an original video, is provided in an app downloadable to the computing device, wherein the computing device is a smartphone, a desktop computer, a tablet computer, a laptop computer, or a smart TV.

50-53. (canceled)

54. The method of claim 1, wherein a video navigation tool is displayed on the screen of the computing device, the navigation tool arranged to receive user input, wherein the video navigation tool includes trim buttons for the start frame of the portion and for the end frame of the portion, to make them frame accurate.

55. (canceled)

56. The method of claim 54, wherein the pointer (e.g. a cursor) is movable on the screen, orthogonally to the length of the video navigation tool, and in response in the video navigation tool the number of frames represented locally in the navigation tool is decreased locally, i.e. the number of frames represented in the navigation tool per unit distance along the navigation tool is decreased locally.

57-64. (canceled)

65. A computer system configured to edit a video file, the computer system including a computer device including a screen, the computer system configured to:
(i) receive a selection of a video file to edit, the video file including a duration;
(ii) present a frame of the video file (e.g. a first frame of the video file) on the screen of the computing device;
(iii) receive on the computing device an input corresponding to a position on the presented frame of the video file on the screen of the device, the input comprising a width coordinate and a height coordinate;
(iv) present on the screen of the computing device a frame of the video file, the presented frame being a frame at a time in the video file that corresponds to the width coordinate as a proportion of the width of the presented frame on the screen, or to the height coordinate as a proportion of the height of the presented frame on the screen, of the duration of the video file, from the start of the video file;
(v) repeat (iii) and (iv) until an input is received by the computing device identifying the presented frame as a start frame of a portion of the video file;
(vi) repeat (iii) and (iv) until an input is received by the computing device identifying the presented frame as an end frame of the portion of the video file;
(vii) save the portion of the video file that is defined by the start frame of the portion of the video file received in (v) and the end frame of the portion of the video file received in (vi).

66. (canceled)

67. A computer program product executable on a computing device including a screen, the computer program product executable on the computing device to:
(i) receive a selection of a video file to edit, the video file including a duration;
(ii) present a frame of the video file (e.g. a first frame of the video file) on the screen of the computing device;
(iii) receive an input corresponding to a position on the presented frame of the video file on the screen of the device, the input comprising a width coordinate and a height coordinate;
(iv) present on the screen of the computing device a frame of the video file, the presented frame being a frame at a time in the video file that corresponds to the width coordinate as a proportion of the width of the presented frame on the screen, or to the height coordinate as a proportion of the height of the presented frame on the screen, of the duration of the video file, from the start of the video file;
(v) repeat (iii) and (iv) until an input is received identifying the presented frame as a start frame of a portion of the video file;
(vi) repeat (iii) and (iv) until an input is received identifying the presented frame as an end frame of the portion of the video file;
(vii) save the portion of the video file that is defined by the start frame of the portion of the video file received in (v) and the end frame of the portion of the video file received in (vi).

68. (canceled)
